(19) United States
(12) Patent Application Publication
(10) Pub. No.: US 2009/0142939 A1
(43) Pub. Date: Jun. 4, 2009

(54) Adapter for card connector

(75) Inventor: Yung-Chang Cheng, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/315,401

(22) Filed: Dec. 3, 2008

(30) Foreign Application Priority Data
Dec. 3, 2007 (TW) 96220459

(51) Int. Cl. H01R 12/00

(52) U.S. Cl. 439/65

(57) ABSTRACT

An adapter has a transmitting board (100) used for a card bus connector and having a top layer (11) having an array of pads (125) disposed on a front portion thereof, a bottom layer (12), a number of rows of holes (13) extending through the top layer and the bottom layer and positioned parallel to the array of the pads of the top layer, and a number of circuits (121) formed on the top layer and connected the rows of holes to corresponding pads. The circuits have a first circuit (11a) and a second circuit (11b). The first circuit radiates outwardly from an outer portion of corresponding holes of an outer row (13a) of the holes and extends far away the second circuit.

### BACKGROUND OF THE INVENTION

1. Field of the Invention

The present invention is directed to an adapter a used in a card bus connector, and more particularly to a transmitting board having circuits formed thereon.

2. Description of Prior Arts

Traditional transmitting board 200 as shown in FIGS. 4-8, comprises a top and a bottom layer 21, 24 for transmitting signals, a first medial ground layer 22 and a second medial ground layer 23 mounted between the top and the bottom layer 21, 24. The first medial ground layer 22 coopers with the top layer 21 to thereby controlling impedance in an acceptable scope. Similarly, the second medial ground layer 23 cooperates with the bottom layer 24 to thereby controlling impedance in an acceptable scope.

However, such a four-layer of the transmitting board 200 will be resulted in a high cost.

Hence, it is desirable to provide an improved transmitting board to overcome the aforementioned disadvantages.

### SUMMARY OF THE INVENTION

An object of the present invention is to provide an adapter comprising a transmitting board having a number of improved circuits formed thereon.

To achieve the above object, A transmitting board used in a card bus connector comprises a top layer having an array of pads disposed on a front portion thereof, a bottom layer, a plurality of holes extending through the top layer and the bottom layer and positioned in different rows parallel to the array of the pads of the top layer, and a plurality of circuits. The circuits are formed on the top layer and connected corresponding conductive holes in different rows to corresponding pads, and comprises at least one pair of circuit adapted for transmitting differential signals between the card bus connector and the express card, the least one pair of circuits having a section extending between a periphery edge of the board and an outmost row of conductive holes opposite to the row of pads and extending far away from the neighboring circuit

Advantages of the present invention are to provide a transmitting board having a top layer and a bottom layer which are easily mounted together to save cost. The distance between the first and second row of differential circuits of the top layer is wide enough to effectively reduce EMI.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a cross-sectional view of a transmitting board of the present invention;

FIG. 2 is a perspective view of a top layer of the transmitting board;

FIG. 3 is a perspective view of a bottom layer of the transmitting board;

FIG. 4 is a cross-sectional view of a transmitting board of a prior art;

FIG. 5 is a perspective view of a top layer of the transmitting board of the prior art;

FIG. 6 is a perspective view of a first medial layer of the transmitting board of the prior art;

FIG. 7 is a perspective view of a second medial layer of the transmitting board of the prior art; and

FIG. 8 is a perspective view of a bottom layer of the transmitting board of the prior art.

### DETAILED DESCRIPTION OF THE PREFERRED EMBODIMENT

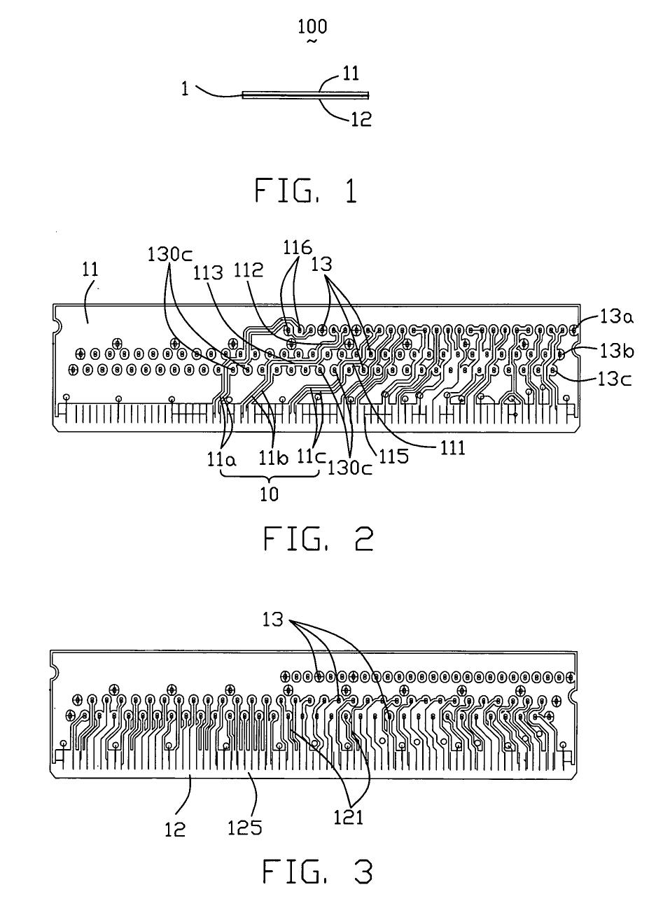

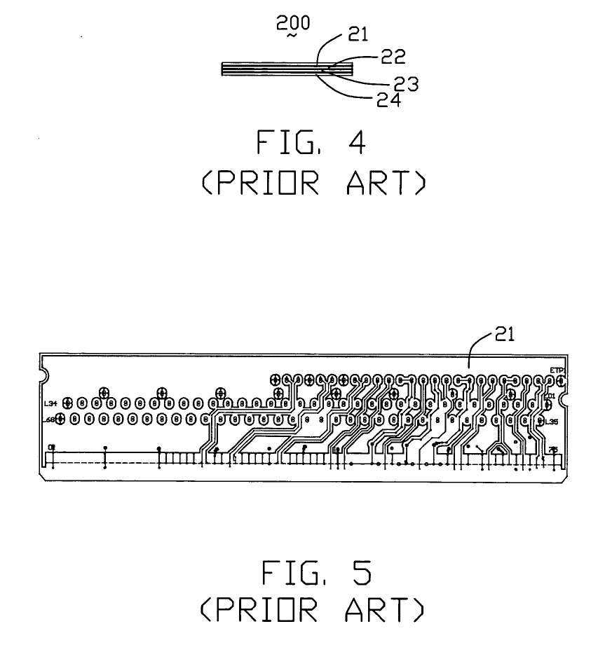

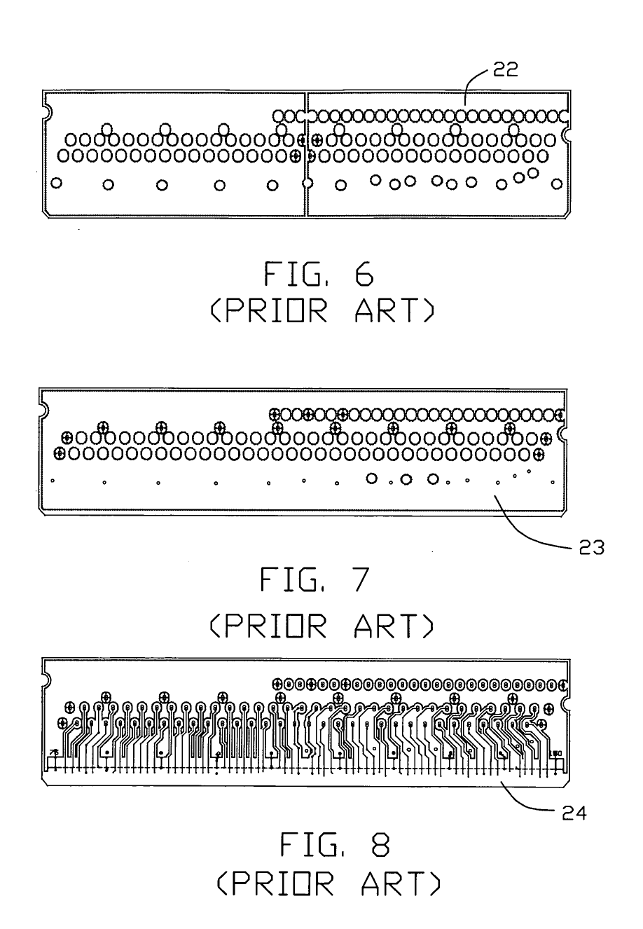

Reference will now be made to the drawing figures to describe the present invention in detail. Referring to FIG. 1, a transmitting board 100 used in a card bus connector (not shown) comprises a top layer 11 having an array of pads 115 disposed on a front portion thereof and a bottom layer 12 for transmitting signals. The top layer 11 and the bottom layer 12 are punched together.

Referring FIGS. 1-3, the transmitting board 100 has a plurality of rows of holes 13 extending through the top layer 11 and the bottom layer 12 and positioned parallel to the array of the pads 115 of the top layer 11. The rows of holes 13 are paralleled to each other and have an outer row of holes 13a, a second row of holes 13b and a third row of holes 13c.

The transmitting board 100 has a plurality of circuits 10 formed on the top layer 11 and connecting to the a second and a third rows of holes 13b, 13c to the pads 115. The circuits 10 comprise a first circuit 11a, a second circuit 11b and a third circuit 11c adjacent to each other for transmitting differential signals. The first circuit 11a radiates outwardly from an outer portion of holes 116 of the outer row of holes 13a and extends far away from the second circuit 11b.

The second circuit 11b has a first horizontal portion 112 formed between the outer and the second rows of the holes 13a, 13b and a second horizontal portion 113 positioned between the second and the third rows of the holes 13b, 13c to extend far away from the third circuit 11c. A minimal distance between the first circuit 11a and the second circuit 11b is larger than a distance between the adjacent two holes 130c of each row of the holes 13a, 13b, 13c. A minimal distance between the second circuit 11b and the third circuit 11c is larger than a distance between the adjacent two holes of each row of the holes 13a, 13b, 13c.

The bottom layer 12 comprises a plurality of second pads 125 disposed on a front portion thereof and a plurality of electrical traces 121 formed thereon for connecting the holes 13 to the second pads 125.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adapter used between a card bus connector and an express card comprising a circuit board, the circuit board comprising:
a top layer having a front portion and an array of pads disposed on the front portion;
a bottom layer;
a plurality rows of conductive holes extending through the top layer and the bottom layer and positioned parallel to the array of the pads of the top layer;
a plurality of circuits formed on the top layer and connected corresponding conductive holes in different rows to corresponding pads, and comprising at least one pair of circuits adapted for transmitting differential signals between the card bus connector and the express card, the least one pair of circuits having a section extending between a periphery edge of the board and an outmost row of conductive holes opposite to the row of pads and extending far away from the neighboring circuit.

2. The transmitting board as claimed in claim 1, the bottom layer comprises a plurality of second pads disposed on a front portion thereof.

3. The transmitting board as claimed in claim 2, the bottom layer comprises a plurality of electrical traces for connecting the conductive holes to the second pads.

4. The transmitting board as claimed in claim 1, the top layer and the bottom layer are punched together.

5. A transmitting board comprising:
a body defining a longitudinal direction and a vertical direction perpendicular to each other, and consisting of opposite upper and lower layers sandwiching a shielding layer therebetween in the vertical direction;
a plurality of circuit pads forms on a bottom edge region of the upper layer;
three rows of through holes arranged in the body along said longitudinal direction, said three rows being categorized with an inner row, a middle row and an outer row wherein the inner row is closer to the circuit pads than said middle row and said outer row, and the outer row is closer to the upper edge region of the upper layer than the middle row and the inner row;
said circuit pads including first, second and third sets of differential pair pads arranged in sequence along said longitudinal direction, said first, second and third sets of differential pair pads connected to the corresponding through holes in sequence along said longitudinal direction in the outer row via first, second and third sets of circuit paths arranged in sequence along said longitudinal direction; wherein
the first, second and third sets of differential pair pads and the corresponding through holes in said outer row are essentially disposed in an oblique manner, and the first set of circuit path first extend beyond said outer row in said vertical direction approaching the upper edge then connected to the corresponding through hole so as to increase the spaced distance with the second set of circuit path.

6. The transmitting board as claimed in claim 5, wherein the second set of circuit path defines a horizontal section between, in said vertical direction, the inner row and the middle row, and said horizontal section is longer than any other horizontal section of the first and third sets of circuit paths between, in said vertical direction, the inner row and the middle row.

7. The transmitting board as claimed in claim 6, wherein the horizontal section of the first set of circuit path between the inner row and the middle row in said vertical direction, is essentially dimensionally equal to the horizontal section of the second set of circuit path between the inner row and the middle row in said vertical direction

8. The transmitting board as claimed in claim 5, wherein the third set of circuit path defines a horizontal section between, in said vertical direction, the inner row and the circuit pads, and said horizontal section is longer than any other horizontal section of the first and third sets of circuit paths between, in said vertical direction, the inner row and the circuit pads.

9. The transmitting board as claimed in claim 8, wherein the first set of circuit path defines a horizontal section between, in said vertical direction, the middle row and the upper edge region, which is essentially dimensionally equal to the horizontal section of the third set of circuit path between, in said vertical direction, said inner row and the circuit pads.

10. The transmitting board as claimed in claim 5, wherein the first set of circuit path defines a horizontal section between the middle row and the upper edge region.

11. The transmitting board as claimed in claim 10, wherein the horizontal section of the first set of circuit path extends essentially in alignment with the outer row in said longitudinal direction.

12. The transmitting board as claimed in claim 5, wherein the first set of circuit path defines a horizontal section located between, in said vertical direction, the middle row and the inner row, and another horizontal section located between, in said vertical direction, the middle row and the upper edge region, the second set of circuit path defines a horizontal section located between, in said vertical direction, the middle row and the inner row, and another horizontal section located between, in said vertical direction, said middle row and the outer row, and the third set of circuit path located between, in said vertical direction, the inner row and the bottom edge region, and another horizontal section located between, in said vertical direction, the inner row and the middle row.
